(19) United States
(12) Patent Application Publication
(10) Pub. No.: US 2007/0183870 A1
(43) Pub. Date: Aug. 9, 2007

(54) STORAGE AND RETRIEVAL SYSTEM

(75) Inventors: Gerhard Forster, Schwarzenbruck (DE); Dominik Graefer, Dortmund-Wellinghofen (DE); Jens Hamann, Fürth (DE); Uwe Ladra, Erlangen (DE); Gerhard Lehmann, Witten (DE); Dietmar Stoiber, Fürth (DE)

Correspondence Address: VAN DYKE, GARDNER, LINN AND BURKHART, LLP, SUITE 207, 2851 CHARLEVOIX DRIVE, S.E., GRAND RAPIDS, MI, 49546, US

(73) Assignee: SIEMENS AKTIENGESELLSCHAFT, Munchen (DE)

(21) Appl. No.: 11/464,932

(22) Filed: Aug. 16, 2006

(30) Foreign Application Priority Data
Aug. 17, 2005 (DE) 10 2005 039 643.7

(51) Int. Cl. B65G 1/04

(52) U.S. Cl. 414/281

(57) ABSTRACT

The invention relates to a storage and retrieval system having at least one mast, which is supported at its lower mast end on a running rail via at least two running wheels and can be moved along the running rail guided by at least one driven running wheel of the running rail, having a guide rail (2), which is arranged in the region of the upper mast end (1) and extends parallel to the running rail, having guide rollers, which are mounted such that they can rotate at the upper mast end (1) and bear against the guide rail (2) on both sides so as to guide the mast. In order to damp the mast oscillations occurring during movement, at least one friction roller (4) is provided that rolls on the guide rail (2) and an eddy current brake (7) is provided that is driven by the friction roller (4).

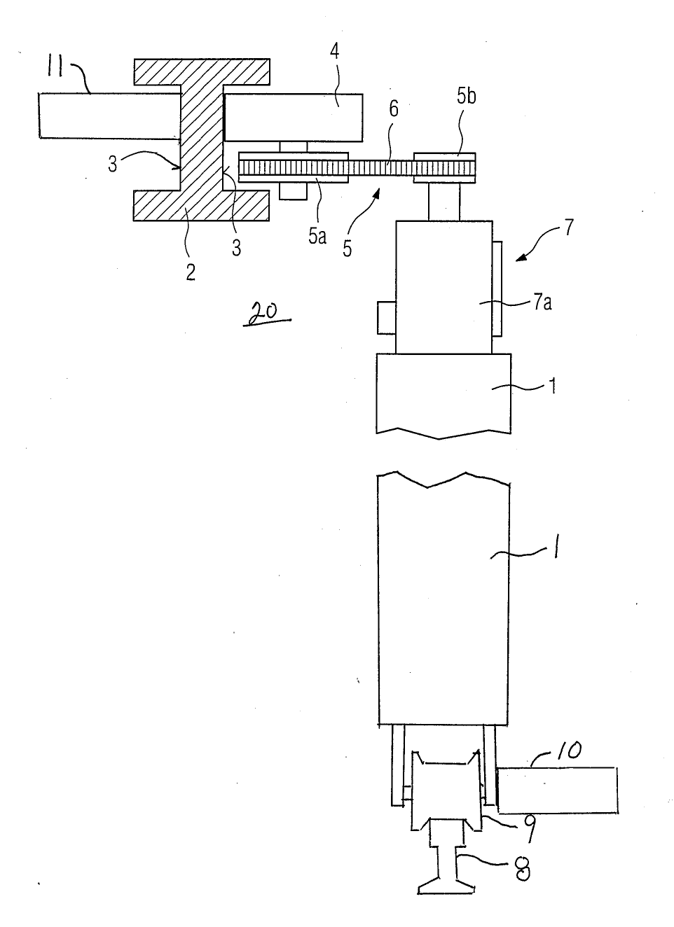

### BACKGROUND OF THE INVENTION

The invention relates to a storage and retrieval system and, in particular, to such a system having at least one mast and a deposit and retrieval system that can be moved vertically along the mast.

Storage and retrieval systems are generally known. They have at least one vertical mast, on which a deposit and removal system can be moved vertically. The mast is supported at its lower end via at least two spaced-apart running wheels, which are mounted such that they can rotate in a base cross arm. The running wheels roll on a base rail, which at the same time is used for guiding the running wheels. One or more running wheels are driven for this purpose by a motor. A further rail is arranged in the region of the upper mast end, which further rail extends parallel to the running rail and is used for guiding the mast end. The guidance takes place by means of guide rollers, which are mounted such that they can rotate at the mast end and roll on both sides on the guide rail.

One disadvantage with the known storage and retrieval system is the fact that, when the storage and retrieval system is moved, oscillations of the upper mast end may occur.

### SUMMARY OF THE INVENTION

The various embodiments of the present invention provide a storage and retrieval system with which the mast oscillations can be damped.

According to an aspect of the invention, a storage and retrieval system includes at least one friction roller and an eddy current brake driven by the friction roller. The friction roller rolls on and bears against the guide rail and is subjected to a force. The eddy current brake absorbs the oscillation energy, such as by converting the oscillation energy into heat and, therefore, provides effective damping of the mast oscillations. In order to damp the oscillations in particular when moving into an intended position, the eddy current brake can be electrically connected.

In one embodiment, the friction roller is subjected to a force by means of magnetic attraction. The eddy current brake may be operated via a permanent gear with an adjustable gear transmission ratio. The guide roller may take on the function of the friction roller. The eddy current brake may be an electric motor.

In one embodiment of the eddy current brake, the electric motor is a squirrel-cage asynchronous motor having an air gap, the size of this air gap being selected such that a correspondingly large magnetic field is induced. In this embodiment, a gear is expediently used for the purpose of adapting to the rotation speed. Particularly large eddy currents may be achieved if the electric motor is in the form of a squirrel-cage asynchronous motor having a constant air gap.

These and other objects, advantages and features of this invention will become apparent upon review of the following specification in conjunction with the drawings.

### BRIEF DESCRIPTION OF THE DRAWINGS

Embodiments of the invention will be described in more detail below with reference to a drawing, whose single figure shows a side elevation of an upper most end of a storage and retrieval system according to an aspect of the invention.

### DESCRIPTION OF THE PREFERRED EMBODIMENT

Referring now to the drawings and the illustrative embodiments depicted therein, the upper mast end 1 of a storage and retrieval system 20 is shown. Details of the lower mast end of the storage and retrieval system are conventional and will not be described in detail. Suffice it to say, the mast is supported at its lower end on a running rail 8 via running wheels 9, only one of which is shown, which roll on the top of the rail. One of the running wheels is driven by a motor 10, with the result that the storage and retrieval system can be moved along the running rail, which at the same time provides for the guidance of the mast of the storage and retrieval system.

In the region of the upper mast end 1, a guide rail 2 arranged in the top region extends parallel to lower running rail 8. In this case, the upper mast end is connected to the guide rail 2 via freely rotatable guide rollers 11, only one of which is shown. The guide rollers roll on the side faces 3 of the guide rail 2. In the illustrated embodiment, the guide rollers subjected to magnetic attraction, bear on both sides against the guide rail 2, although spring force, or the like, may be used to provide attraction. The desired frictional relationships are achieved by means of the guide rollers being pressed against the guide rail 2.

As shown in the figure, a further roller, which is subjected to a force and is in the form of a friction roller 4, bears against one of the two side faces 3. When storage and retrieval system 20 is moved, friction roller 4 rolls along the guide rail 2 and at the same time bears against the guide rail, such as at a face 3. As will be described in more detail below, the friction roller may be subjected to a force by means of magnetic attraction.

The friction roller 4 is connected to the mast end 1 via a gear assembly 5 having gear wheels 5a, 5b, the gear wheels 5a, 5b being connected to one another via a toothed belt 6. By varying the diameter of one or both wheels 5a, 5b, the gear ratio may be changed to suit the application.

The gear wheel 5b is positioned on the shaft of an eddy current brake 7, which in this case is in the form of a squirrel-cage asynchronous motor 7a and is fixedly connected to the mast end 1. The electric motor has a constant air gap to perform the function of an eddy current brake 7, i.e., the squirrel-cage asynchronous motor 7a is electrically connected in a corresponding manner and therefore converts the mechanical movement energy of the mast tip 1 into heat via eddy currents. The air gap of motor 7a is selected in terms of its size such that in each case a correspondingly large magnetic field is induced. In this case, the gear 5 is used for adapting the rotation speed to the optimum rotation speed of the squirrel-cage asynchronous motor 7a, i.e., the rotation speed at which the asynchronous motor eddy current brake 7 is at its most effective.

A direct current may be applied to the asynchronous motor 7a when the mast is approaching the intended stopping position. In this manner, damping of the mast movement may be limited to positions of the mast when it is moving into the intended stopping position. The eddy current brake 7a can otherwise be selectively connected during the movement or prior to the movement of the mast to the intended stopping position.

The use of the gear 5 makes it possible to position the asynchronous motor 7a at various locations along the mast. It is therefore not necessary for the asynchronous motor 7a to be attached directly in the region of the guide rail 2.

In an alternative embodiment, friction roller 4 may also perform the function of one of the guide rollers 11. In this manner, one roller may both partially guide the mast and at the same time transmit the movement of the mast tip to the squirrel-cage asynchronous motor 7a. In this manner, it is possible to omit the guide rollers 11 which lie on the same side as the friction roller 4, the friction roller 4 also taking on the guiding function on this side.

Alternatively, the electric motor may be in the form of a synchronous motor having a short-circuited winding to provide the desired damping effect.

Changes and modifications in the specifically described embodiments can be carried out without departing from the principles of the invention which is intended to be limited only by the scope of the appended claims, as interpreted according to the principles of patent law including the doctrine of equivalents.

1. A storage and retrieval system, comprising:
at least one mast, said at least one mast adapted to be supported at a lower mast end on a lower rail via at least one running wheel and is adapted to be driven along the running rail by at least one driven running wheel;
an upper guide rail at an upper mast end, said upper guide rail extending parallel to the running rail having at least one guide roller, said at least one guide roller being mounted such that said at least one guide roller bears against said guide rail so as to guide said mast;
at least one friction roller, wherein said at least one friction roller rolls on said upper guide rail and bears against said upper guide rail; and
an eddy current brake driven by said friction roller, said at least one friction roller mounted for movement with said upper mast end, said eddy current brake damping oscillations of said upper mast end.

2. The storage and retrieval system as claimed in claim 1, wherein said eddy current brake is selectively electrically actuated, wherein said eddy current brake is electrically actuated when said upper mast end moves into an intended stopping position.

3. The storage and retrieval system as claimed in claim 2, wherein said friction roller is attracted to said upper guide rail by means of magnetic attraction.

4. The storage and retrieval system as claimed in claim 3, including a gear assembly for operating said eddy current brake.

5. The storage and retrieval system as claimed in claim 4, wherein said gear assembly includes an adjustable transmission ratio, wherein an amount of damping is adjustable by adjusting the transmission ratio.

6. The storage and retrieval system as claimed in claim 4, wherein at least one of the guide rollers defines said friction roller.

7. The storage and retrieval system as claimed in claim 6, wherein said eddy current brake is in the form of an electric motor.

8. The storage and retrieval system as claimed in claim 7, wherein said electric motor is in the form of a squirrel-cage asynchronous motor having an air gap.

9. The storage and retrieval system as claimed in claim 8, wherein the size of the air gap being selected to produce a correspondingly large magnetic field.

10. The storage and retrieval system as claimed in claim 8, wherein said air gap is constant.

11. The storage and retrieval system as claimed in claim 1, wherein said eddy current brake comprises a synchronous motor having a short-circuited winding.

12. The storage and retrieval system as claimed in claim 1, wherein said eddy current brake is only electrically activated when moving into an intended stopping position of said mast and remains electrically deactivated during the remaining driving time of said mast.

13. The storage and retrieval system as claimed in claim 1, wherein said friction roller is attracted to said upper guide rail by means of magnetic attraction.

14. The storage and retrieval system as claimed in claim 1, including a gear assembly for operating said eddy current brake.

15. The storage and retrieval system as claimed in claim 14, wherein said gear assembly includes an adjustable transmission ratio, wherein an amount of damping is adjustable by adjusting the transmission ratio.

16. The storage and retrieval system as claimed in claim 1, wherein at least one of the guide rollers defines said friction roller.

17. The storage and retrieval system as claimed in claim 1, wherein said eddy current brake is in the form of an electric motor.

18. The storage and retrieval system as claimed in claim 17, wherein said electric motor is in the form of a squirrel-cage asynchronous motor having an air gap.

19. The storage and retrieval system as claimed in claim 18, wherein the size of the air gap being selected to produce a correspondingly large magnetic field.

20. The storage and retrieval system as claimed in claim 18, wherein said air gap is constant.
